(19) United States
(12) Patent Application Publication
(10) Pub. No.: US 2025/0002680 A1
(43) Pub. Date: Jan. 2, 2025

(54) METAL-FILLED RESIN FORMULATION, 3D PRINTING METHOD, AND ADDITIVELY MANUFACTURED COMPONENT

(71) Applicants: Siemens Healthineers AG, Forchheim (DE); Cubicure GmbH, Wien (AT)

(72) Inventors: Robert GMEINER, Wien (AT); Christian GORSCHE, Wien (AT); Elena MORGANTI, Wien (AT); Konstanze SEIDLER, Wien (AT); Nick DINKEL, Mehrnbach (AT); Michael GRASRUCK, Eckental Forth (DE); Rainer HÄUPL, Krummennaab (DE); Michael OTT, Speinshart (DE); Stefan WIRTH, Erlangen (DE); Jan WREGE, Erlangen (DE)

(21) Appl. No.: 18/705,555

(22) PCT Filed: Oct. 25, 2022
(86) PCT No.: PCT/EP2022/079777

§ 371 Date: Apr. 27, 2024

(30) Foreign Application Priority Data
Oct. 27, 2021 (EP) 21204925.8

(51) Int. Cl. C08K 3/08; B29C 64/135; B33Y 10/00; B33Y 70/10; B33Y 80/00; C08F 2/46; C08F 220/56

(52) U.S. Cl. CPC C08K 3/08; B29C 64/135; C08F 2/46; C08F 220/56; B33Y 10/00; B33Y 70/10; B33Y 80/00; C08K 2003/0887; C08K 2201/005

(57) ABSTRACT

The present invention relates to a metal-filled resin formulation, more particularly for a 3D printing method, on the basis of layer-by-layer photopolymerization for the manufacture of a component, wherein the resin formulation contains a photopolymerizable matrix component, a dense metal filler having a specific minimum volume fraction, and a photoinitiator. A component is additively manufactured by the layer-by-layer selective curing of the metal-filled resin formulation by means of irradiation with light. The invention in particular relates to the high-precision manufacture of radiation-absorbing components on the basis of lithographic additive processes such as SLA; because of the special choice of the formulation used, wall thicknesses down to less than 100 μm are possible while still achieving good radiation hardness and good surface quality.

### FIELD OF THE INVENTION

The present invention relates to a metal-filled resin formulation, in particular for a 3D printing process, and to a 3D printing process in which such a metal-filled resin formulation is used for the manufacture of a component. In addition, the invention to a component which is manufactured in particular with such a 3D printing process. The invention here concerns more particularly the additive manufacture of three-dimensionally shaped components for absorbing electromagnetic radiation, e.g. X-ray radiation.

### TECHNICAL BACKGROUND

In certain technological areas of application, radiation-absorbing materials and components manufactured from them are being increasingly used in a wide variety of geometries, some of which are complex. The lead previously used on a standard basis for such applications has been successively replaced here by other metals and polymer/metal composites. In the case of polymer/metal composites, a metal filler with high density or high atomic number (e.g. tungsten) is nowadays often embedded into a thermoplastic matrix (e.g. polyamides). This material is typically processed into industrial components using conventional polymer shaping processes, such as injection molding or extrusion (see, for example, DE 10 2004 027158 A1, US 2008/0023636 A1, DE 10 2007 028231 A1 and WO 2012/034879 A1).

A higher proportion of metal filler can achieve a higher density and thus better component performance in terms of radiation absorption, but may entail acceptance of compromises in the resulting mechanical strength, which may make it difficult to process such materials. In principle, with the aforementioned conventional approaches, complex geometries can be realized only at high cost and effort, if at all. As a result of progressive miniaturization or onward development of application solutions, however, there is a great requirement for the production of highly complex geometries with low wall thicknesses and high precision, in light of which conventional shaping processes are increasingly reaching their limits.

In generative or additive manufacturing processes, also generally referred to as “3D printing processes”, one or more starting materials are sequentially layered and cured, based on a digitized geometric model of an n object. For example, in stereolithography (SL or SLA), a component is constructed layer by layer from a light-curable resin formulation such as acrylic, epoxy or vinyl ester resin, for example. For this purpose, the respective resin formulation is provided in a bath in liquid form (viscosities typically in the range<2 Pa s) and cured at the surface by polymerization, so-called photopolymerization, by means of laser irradiation in selected regions to give a material (e.g. plastic or composite). After each step, the thin layer of material formed in this way is lowered into the liquid a few millimeters and returned to a position that is less than the previous one by the amount of one layer thickness. The liquid resin formulation is then evenly distributed over the workpiece by means of a wiper or squeegee. The laser then travels over the liquid surface again, creating a three-dimensional component step by step.

3D printing offers exceptional design freedom and allows the production of objects at manageable cost and effort, including objects that could not be produced with conventional methods or would be producible only at considerable cost and effort. For this reason, 3D printing processes are currently very prevalent in industrial design, medical technology, the automotive industry, the aerospace industry or generally in industrial product development, in which a resource-efficient process chain is used for the demand-oriented small-scale and large-scale manufacture of individualized components and also for the flexible and on-demand production of required spare parts.

For example, A. T. Sidambe et al., “Laser powder bed fusion of a pure tungsten ultra-fine single pinhole collimator for use in gamma ray detector characterisation,” International Journal of Refractory Metals and Hard Materials, Volume 84, 2019, describe the use of an additive beam fusion process for manufacturing a thin collimator structure made of tungsten.

Certain additive manufacturing technologies such as SLA, LCD (liquid crystal display) processes, digital light processing (DLP) or other light-emitting processes with an active light mask, combinations are or thereof, characterized by outstandingly high precision and thus offer a particularly promising key to the manufacture of ultra-fine shaped parts.

For example, the publication US 2020/0077966 A1 describes a two-stage process for manufacturing a collimator made of tungsten, in which after an SLA step a layer of a radiation-absorbing metal is applied to the polymerized layer by means of cathode sputtering. This metal layer is then lifted off the SLA layer and is retained as a layer part of the collimator. The procedure is repeated accordingly as a layer process to manufacture the final collimator from tungsten. However, the direct manufacture of a collimator from a radiation-absorbing material using SLA would be a substantially simplified and more economical process solution.

Furthermore, WO 2020/198404 A1 describes the use of a colloid of polymeric macromolecules in a solvent as a matrix material, to which metal particles may also be admixed. In a generative manufacturing process, green parts are first produced using this material, and are dried in a further step under the influence of temperature.

The publication WO 2020/141519 A1 describes the additive manufacture of radiation-absorbing and metal-containing radiological phantoms using lithographic processes. Metal particles with nanometer sizes are used therein.

The publication WO 2019/048963 A1 describes the production of dental prostheses or dental restorations.

Suitable photoinitiators for initiating a correspondingly necessary photoreaction are described in, for example, W. Arthur Green, “Industrial Photoinitiators: A Technical Guide,” Taylor & Francis Group, 2010, ISBN: 978-1-4398-2745-1.

### SUMMARY OF THE INVENTION

Against this background, the object of the present invention is to find precise yet practical solutions for the manufacture of radiation-absorbing components, with which preferably even complex structures can be manufactured cost-efficiently.

According to the invention, this object is achieved by a metal-filled resin formulation having the features of claim 1, by a 3D printing process having the features of claim 9, and by an additively manufactured component having the features of claim 11.

Envisaged accordingly are the following:
A metal-filled resin formulation, in particular for a 3D printing process, on the basis of layer-by-layer photopolymerization for the manufacture of a component, preferably a radiation-absorbing component, wherein the resin formulation contains: a photopolymerizable matrix component which comprises at least one of monomers, oligomers and prepolymers from the group composed of mono- and/or polyfunctional radically and/or cationically polymerizable compounds, a metallic filler which has a density of at least 8.5 g cm⁻³, preferably at least 10 g cm⁻³, where the photopolymerizable matrix component has a volume fraction of 5-80 vol %, preferably 5-70 vol %, particularly preferably 5-60 vol %, based on a sum of the photopolymerizable matrix component and the metallic filler, and where the metallic filler has a volume fraction of 20-95 vol %, preferably 30-95 vol %, particularly preferably 40-95 vol %, based on a sum of the photopolymerizable matrix component and the metallic filler, and a photoinitiator which is adapted to the photopolymerizable matrix component and the light wavelength used for the photopolymerization, where the photoinitiator has a content of 0.05-10 phr, preferably 0.1-5 phr, particularly preferably 0.3-3 phr, based on the photopolymerizable matrix component, where the metallic filler comprises a particulate fine fraction of less than 10% with a particle size smaller than one micrometer.
A 3D printing process on the basis of layer-by-layer photopolymerization for the manufacture of a component, more particularly a radiation-absorbing component, using a metal-filled resin formulation according to the invention, wherein the 3D printing process comprises: provision of the metal-filled resin formulation in a manufacturing bath, on a manufacturing bed and/or as a wet layer, and layer-by-layer selective curing of the metal-filled resin formulation by polymerization in manufacturing the bath, on the manufacturing bed and/or in the wet layer by means of selective light irradiation to form the component.
An additively manufactured component, more particularly a radiation-absorbing component, which is manufactured with a 3D printing process according to the invention.

An idea underlying the present invention is to incorporate a high-density metal material into a light-curable resin formulation and to bind this composite material into a virtually arbitrarily complex component shape by means of a light-based and thus particularly precise additive process. For this purpose, the present invention uses a metal-filled resin formulation which combines polymerizable matrix components with one or more metallic filling materials. A photoinitiator initiates a fast photoreaction and thus gives the composite material, in combination with the matrix component, sufficient green strength to maintain the desired dimensional fidelity during the 3D printing process and in post-processing. The light irradiation can optionally be applied directly to the surface of the resin formulation, or introduced into the resin formulation by a carrier medium permeable for light irradiation.

In addition to ensuring ultra-fine and complex geometries with wall and/or structural thicknesses in the order of 100 μm with a high resolution of up to 10 μm at the same time and also precision of the 3D component in the printing process with appropriate surface quality, the cured composite material is particularly capable of absorbing relevant radiation doses with energies in the keV range or beyond at the stated wall thicknesses. This is achieved by the use of radiation-absorbing metals, which preferably have a density similar to or greater than lead and achieve a filler content of at least 20% by volume in the composite. The resulting density of the photopolymerized composite material can thus also be set sufficiently high, e.g. in the range>4.5 g cm⁻³.

Consequently, the effectiveness and performance of technical 3D components manufactured in this way can also thus be significantly improved, e.g. improved direction of the light in a radiation collimator. The ability to quickly and efficiently provide production parts and spare parts for new and existing application solutions is another major advantage of the 3D printing technologies used. Light-based technologies are particularly advantageous here, as their precision enables components to be manufactured with a consistent surface quality compared to conventional manufacturing methods such as injection molding. This also results in the desired backward compatibility for cost-effective on-demand manufacture of spare parts in existing areas of application.

Currently existing material solutions, which can be produced by conventional manufacture and consist of a metal-filled composite material with the desired radiation-absorbing properties, are based on a thermoplastic matrix. However, the additive processing methods that can be used are limited to extrusion-based 3D printing processes (e.g. fused filament fabrication) or powder bed processes (e.g. laser powder bed fusion), which have an achievable resolution or feature size (achievable component resolution greater than 50 μm, minimum wall thicknesses greater than 150 μm) significantly below the possibilities of light-based 3D printing technologies. Especially when composite materials are used, these limitations become even more significant.

Another advantage of producing composite materials via SLA-based technologies is the efficient usage of materials, as all of the formulation that is not polymerized can be reused in the printing process.

The digital manufacturing aspect of light-based 3D printing processes primarily enables tool-free manufacture of the target geometry. This reduces the production risk of new geometries many times over, since no start-up costs for a new production campaign have to be pre-financed and no waiting times for tool manufacture have to be accounted for. Without this production risk, geometry and product iterations can be quickly and cost-effectively transferred to field testing, and product optimization can therefore be driven forward on a permanent basis.

Advantageous embodiments and developments are apparent from the further dependent claims and also from the description with reference to the figures of the drawing.

According to one development, the photopolymerizable matrix component may comprise acrylate, in particular methacrylate, acrylamide, in particular methacrylamide, vinyl esters, vinyl ethers and/or cyclic ethers or the like.

In principle, however, candidates here include any light-curing matrix component or correspondingly behaving material which is structurally crosslinked and cured under light irradiation and in particular in the presence of suitable photoinitiator systems by photochemical processes.

According to one development, the photopolymerizable matrix component may be adapted for curing under irradiation with light of a wavelength of 150-1000 nm, preferably 200-550 nm.

This means that the photopolymerizable matrix component can be cured in particular with UV light as well as with near-infrared and visible light. The photoinitiator(s) are to be coordinated accordingly to these wavelengths. Achievable through-curing depths and the hereby defined layer thicknesses of the additive structure can be, for example, in the range of 10-500 μm, preferably 40-300 μm, particularly preferably 70-250 μm.

According to one development, the metallic filler may comprise tungsten, molybdenum and/or tantalum or another suitable metal.

In principle, candidates here include any metal, any metallic material and/or any metallic material combination which has a suitable density of at least 8.5 g cm⁻³, preferably at least 10 g cm⁻³, particularly preferably comparable to or greater than that of lead.

According to one development, the corresponding resin formulation may have a density of at least 4.5 g cm⁻³, preferably at least 6 g cm⁻³, particularly preferably at least 8 g cm⁻³.

According to the invention, the metallic filler comprises a particulate fine fraction of less than 10% with a particle size smaller than one micrometer.

The strong absorption effect of the metal fillers used, especially in the spectral range of 150-1000 nm, may limit the achievable curable layer thickness. This limitation is heavily dependent on the filler level and on the particle size, shape and distribution. The higher the filler level and/or the smaller the particle size, the greater the impediment to light entering the formulation, allowing polymerization and thus structuring of the photopolymerizable matrix component. For this reason, the particulate fine fraction is advantageously kept small.

According to one development, the metallic filler may have a particle size distribution with D10>2 μm and D90<100 μm.

In addition to the average particle size, the particle size distribution is also important. The particle size distribution of a sample can, for example, be measured by means of laser diffraction and characterized using different indices Dxx. For example, D50 means that 50% of the particles are smaller than the specified value. Other important parameters include D10 as a measure for the smallest particles, and also D90 and, where appropriate, D95, D99 and/or D100 for the larger particles in the sample. For example, the closer that D10 and D90 are, the narrower the particle size distribution.

Presently, the particle size of the smallest particles should be substantially more than 2 μm (index D10). The upper particle size limit D90 is defined by the desired wall thickness and the required surface roughness (e.g. less than 100 μm).

According to one development, the metallic filler may have not only a monomodal but also a bi- or multimodal particle size distribution.

Particle size distributions with multiple maximum values in the density distribution are called multimodal, i.e. bimodal, trimodal, etc. Multimodal distributions are preferred if high filling levels are to be achieved or facilitate the processability of the metal-filled resin formulation. The density distribution of the metallic filling particles thus presently attains either only a single maximum or ideally two or more maxima.

According to one development, the metallic filler may comprise rounded and/or round particles.

For example, rounded and/or round metal particles in the resin formulation according to the invention lead to an increase in flowability and/or a reduction in the abrasion behavior in the process, which has a beneficial effect on the processing of the resin formulation.

According to one development, the metal-filled resin formulation may further contain a rheology additive, a nanoparticle filler with particle sizes smaller than one micrometer, a light absorber, an adhesion promoter, a defoamer, a leveling additive and/or a thermal initiator. In particular, the respective additive may be present at a content of 0.01-20 phr based on the photopolymerizable matrix component.

For example, the metal particles of the metallic filler can be stabilized by addition of rheology additives in the matrix component, by the rheology additives forming a network of physical bonds to prevent the particles from sinking within the matrix component.

As an alternative or in addition, nanoparticles can be added to prevent sinking.

The metal-filled resin formulations used preferably have a corresponding sedimentation stability (e.g. more than four weeks at room temperature and/or more than two days at process temperature) in order to ensure the storage stability of the resin product and further an isotropic distribution of filler in the layers of the manufactured component during the 3D printing process.

If light scattering occurs at the particles during the 3D printing process, the addition of light-absorbing substances (e.g. UV absorbers, HALS) can prevent curing outside the desired exposed region.

In addition, further substances or mixtures can be added to promote curing (e.g. UV-curing adhesion promoters, defoamers to reduce air pore content, leveling additives for a stable resin layer in the manufacturing bed, etc.).

According to one development, the 3D printing process may comprise an active light mask from the process types SLA (e.g. laser), LCD process (e.g. display), DLP (e.g. projector) and/or other suitable light-emitting processes with an active light mask. It is understood here that the skilled person can combine appropriate processes.

By far the most precise additive manufacturing processes are light-based technologies such as stereolithography (SLA) or digital light processing (DLP), where so-called photopolymerizable resin formulations (mostly based on acrylate or epoxy) are used. With these technologies, the resin formulations used can be locally and precisely cured layer by layer by light excitation, which enables the manufacture of 3D components with a resolution of down to 10 μm (in the case of SLA) and component features down to <100 μm. In addition, such 3D printing processes are advantageous over material extrusion or powder bed processes by virtue of their high material efficiency, reduced energy consumption, achievable component density and excellent scalability.

For example, so-called hot lithography can be used, a special form of SLA, see for example the publication WO 2018/032022 A1, which provides for the processing of highly filled formulations by means of targeted heating of process zones in combination with a layer doctor technology; as a result, among other things, excellent material resistance and at the same time a smooth surface are achieved. In particular, hot lithography is therefore suitable for processing filled material systems, such as metal-filled resin formulations according to the invention, and thus for the production of technical 3D components from composite materials with high precision and surface quality.

According to one development, the component may be designed to absorb electromagnetic radiation with an energy of at least 1 keV, in particular at least 50 keV.

For example, the component may be designed to absorb electromagnetic radiation with energies in the range from 50 keV to about 300 keV. Wall thicknesses can be selected accordingly, for example, in the range of 100±50 μm and higher, depending on the radiant energy.

According to one development, the component can have wall thicknesses of less than 150 μm.

The minimum wall thicknesses can therefore in particular be down to below 100 μm.

According to one development, the component may have a density of at least 4.5 g cm⁻³, preferably at least 6 g cm⁻³, particularly preferably at least 8 g cm⁻³.

The resulting density of the photopolymerized composite material can therefore be in the range of lead or even higher.

According to one development, the organic constituent can be burned out of the component (green part) in a further process step by means of thermal processes (e.g.: convection oven) and a resultant brown part can be supplied to a sintering process, to form a metallic, metal-oxidic or a combination of metallic and metal-oxidic shaped part.

According to one development, the burned-out component can also be infiltrated with a metallic and/or non-metallic matrix, so allowing the properties (e.g. radiation absorption, strength, etc.) to be adjusted.

The above configurations and developments can be combined arbitrarily with one another, insofar as is rational. Further possible embodiments, developments and implementations of the invention embrace combinations of features of the invention described in the foregoing or in the text below in relation to the exemplary embodiments, even where such combinations are not stated explicitly. In particular, the skilled person will also add individual aspects as improvements or complements to the respective basic form of the present invention.

### SUMMARY OF THE DRAWING

The present invention is explained in more detail below with reference to the exemplary embodiments specified in the schematic figures of the drawing, in which:

FIG. 1 shows a schematic view of a 3D printing apparatus for performing a 3D printing process according to an embodiment of the invention;

FIG. 2 shows a detailed view of a component which is manufactured with the 3D printing apparatus of FIG. 1 on the basis of a metal-filled resin formulation according to an embodiment of the invention; and

FIG. 3 shows a schematic flowchart of the 3D printing process used in FIGS. 1 and 2.

The accompanying figures of the drawing are intended to provide a further understanding of the embodiments of the invention. They illustrate embodiments and serve in connection with the description for the clarification of principles and concepts of the invention. Other embodiments and many of the stated advantages are apparent with regard to the drawings. The elements of the drawings are not necessarily shown to scale with each other.

In the figures of the drawing, identical, functionally identical and equivalent elements, features and components—unless otherwise specified—are each provided with the same reference signs.

### DESCRIPTION OF EXEMPLARY EMBODIMENTS

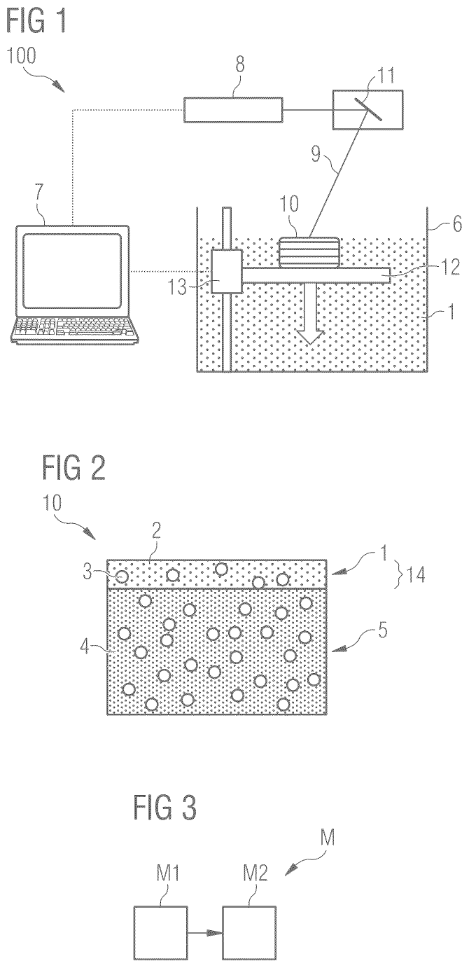

FIG. 1 shows a schematic view of a 3D printing apparatus 100 for performing a 3D printing process M according to an embodiment of the invention. A schematic flowchart of the process M is shown in FIG. 3.

The process M is used in the embodiment outlined below for the manufacture of a radiation-absorbing component 10. The component 10, for example, may be a stray radiation collimator, which is used for the suppression of unwanted stray radiation for radiation detectors in transmission tomography devices, such as X-ray computer tomographs, for example. In examinations, e.g. in X-ray computed tomography, such stray radiation can arise through interaction with objects. To prevent unwanted artefacts in the acquired images, this stray radiation is usually intercepted by corresponding collimator elements made of a suitably dense metal or metal composite material before entering the detector.

For radiation-absorbing structures of these kinds, and others, polymer/metal composites are nowadays often shaped by conventional polymer shaping processes, such as injection molding or extrusion, using a metal filler with high density and/or high atomic number, such as tungsten, for example. The density of the resulting composite is at least 4.5 g cm⁻³, which corresponds to a tungsten filling level of >18.5 vol %, but higher filling levels are more ideal to achieve a density similar to or greater than lead. It should be noted that although higher density improves component performance in terms of radiation absorption, it is necessary to take account of the lower mechanical strength of the composite material, which can lead to brittleness in the final components. Furthermore, the processing of such composite materials is made more difficult with a higher proportion of metal filler, and complex geometries can no longer be realized. The polymer matrix must therefore be specifically optimized in order to ensure good processability and the required (thermo) mechanical properties.

As a result of progressive miniaturization or onward development of application solutions, there continues to be a great requirement for the production of highly complex geometries (wall thicknesses down to <100 μm and resolution or precision down to 10 μm, to increase the sensitivity of a collimator, for example), which cannot be achieved using conventional shaping processes. Furthermore, with the mass production solutions mentioned, the on-demand manufacture of backward-compatible spare parts is not economically realizable or it must, as per the current situation, be cushioned by sufficient storage capacities.

Therefore, it is presently proposed that additive manufacturing technologies, i.e. 3D printing, are used for the manufacture of such precise, radiation-absorbing shaped parts. Hitherto realized 3D printing processes which directly process metallic materials (e.g. laser powder bed fusion; see the publication by A. T. Sidambe et al. mentioned in the introduction) or which work with thermoplastic-based metal composites comparably to injection molding or to extrusion processes (e.g. fused filament fabrication; see e.g. US 2020/0024394 A1) are, however, very limited in terms of the achievable component resolution (>50 μm) and the minimum achievable wall thicknesses (>150 μm). Especially when composite materials are used, these limitations become even more significant.

For this reason, presently, the innovative approach is pursued of structuring a metal-filled resin formulation using a stereolithographic 3D printing process such as SLA with high precision, down to <100 μm in component features or resolution down to 10 μm, layer by layer, locally and in precisely free-form manner, by light excitation. The metal-filled resin formulation here is chosen in such a way that the final component 10 has a material density of at least 4.5 g cm⁻³ or more for the absorption of radiation with energies, for example, above 50 keV. The access to complex geometries and low wall thicknesses enables improved part performance in many areas of application (e.g. improved direction of light in a collimator). In addition, such 3D printing processes are advantageous over material extrusion or powder bed processes by virtue of their high material efficiency, reduced energy consumption, achievable component density and scalability.

The process M comprises accordingly, under M1, provision of the metal-filled resin formulation 1 in a manufacturing bath and/or on a manufacturing bed 6 and/or generally by provision of a wet layer of a metal-filled resin formulation 1. The process M further comprises, under M2, layer-by-layer selective curing of the metal-filled resin formulation 1 by photopolymerization in the manufacturing bath and/or on the manufacturing bed 6 and/or in the provided wet layer by means of selective light irradiation to form the component. The light irradiation can optionally be applied directly to the surface of the resin formulation (FIG. 1), or introduced into the resin formulation by a carrier medium permeable for the light irradiation.

The corresponding illustrative structure for a “top down” process is shown in FIG. 1. The metal-filled resin formulation 1 is located in a manufacturing bath 6. A control device 7, e.g. a computer, controls on the one hand a laser 8, which moves a laser beam 9 via a deflection mirror 11 selectively over a surface of the resin formulation 1 in the manufacturing bath 6. On the other hand, the control device 7 controls a lowering device 13 within the manufacturing bath 6 in order to gradually lower a work platform 12, on which the component 10 is built up layer by layer by a curing of the resin formulation 1 caused by the laser radiation.

The formulation 1 used here comprises a mixture of a photostructurable matrix component (component A) and one or more metallic fillers (component B). The formulation 1 is composed as follows:
Photopolymerizable matrix component A: Monomer, oligomer, prepolymer or mixture thereof from the group of mono- and/or polyfunctional radically and/or cationically polymerizable compounds, such as (meth) acrylates, (meth) acrylamides, vinyl esters, vinyl ethers, cyclic ethers and the like having a volume fraction of 5-80 vol %, preferably 5-70 vol %, particularly preferably 5-60 vol %, based on the sum of components A and B.
Metallic filler, in particular radiation-absorbing, e.g. a refractory metal (component B): Density≥8.5 g cm⁻³, preferably at least 10 g cm⁻³, and volume fraction of 20-95 vol %, preferably 30-95 vol %, particularly preferably 40-95 vol %, based on the sum of components A and B, preferably tungsten, molybdenum or tantalum, preferably with a low particulate fine fraction (less than 10%<1 μm), a D10>2 μm and a D90<100 μm, preferably monomodal or bimodal distribution, preferably rounded or round particle shape.
Photoinitiator: Coordinated to the photopolymerizable component A and to the wavelength of the light used for curing, having a content of 0.05-10 phr, preferably 0.1-5 phr, particularly preferably 0.3-3 phr, based on component A.

The photopolymerizable component A is cured by means of coordinated photoinitiators through targeted irradiation by means of light of a wavelength of 150-1000 nm, preferably 200-550 nm. The achievable through-curing depths and thus the layer thicknesses are in the range of 10-500 μm, preferably 40-300 μm, particularly preferably 70-250 μm. The matrix component A together with the photoinitiator enables a fast photoreaction and gives the composite material sufficient green strength to maintain the desired dimensional fidelity during the 3D printing process and in post-processing.

Optionally, additional components can be included in the formulation, such as, for example, rheology additives, fillers with particle size<1 μm, absorbers, adhesion promoters, defoamers, leveling additives, thermal initiators, each at a content of 0.01-20 phr based on component A.

FIG. 2 shows a detailed view of the component 10 from FIG. 1 during manufacture.

In a lower region of the component 10, the metal-filled resin formulation 1 has already been converted into a cured material 5. Located thereon is a thin layer, of a layer thickness 14 determined by the position of the lowering device 13, of the still uncured metal-filled resin formulation 1, i.e. of the photopolymerizable matrix component 2 together with the metallic filler material 3 dispersed therein. By selective laser irradiation, this layer can then be cured specifically in certain regions and the component 10 can be extended upward in this way, layer by layer.

The resin formulation shown and the photopolymer composites manufactured by means of SLA offer a decisive improvement in quality and performance of a corresponding technical 3D component (e.g.: improved direction of the light in a radiation collimator) with the achieved material properties (density>4.5 g cm⁻³ for radiation absorption in the 50-300 keV range or sufficient radiation resistance of the matrix), in combination with the described geometry freedom of the producible 3D components (minimum wall thicknesses down to <100 μm), the achievable component resolution (down to 10 μm) and resulting surface quality.

The resin formulation can be detected via particle determination (density, SEM, particle size determination, XRF), matrix determination via Fourier transform IR spectroscopy, NMR spectroscopy, GPC, LC/GC-MS, UV/VIS spectroscopy and/or UV exposure test or the like.

A correspondingly lithographically produced component 10 can be analyzed, for example, via microscopy of the SLA layer structure and via the particle sizes, shapes and/or distributions used. The particle distribution, for example, can be used to estimate the approximate filler content. Energy dispersive X-ray spectroscopy (EDS) can be used, for example, for the analysis of the filler used, and by density determination and ATR-IR spectroscopy, for example, the underlying matrix and the filler content can be determined, taking into account the information obtained by means of EDS. An associated radiation absorption can be measured relative to pure tungsten or lead, where a defined radiation intensity can be imposed on plaques and measured by radiation penetration. Finally, the absorption of stray radiation and also possible artefacts/radiation originating from the material are relevant, and can be tested in the respective application.

In other words, the component 10 manufactured with the present process M can be distinguished from conventionally produced structures by suitable measuring processes both in terms of its material composition and in terms of its structuring (wall thicknesses, etc.).

In the preceding detailed description, different features have been amalgamated in one or more examples to improve the consistency of the presentation. However, it should be made clear that the above description is merely illustrative, but not in any way limited, in nature. It covers all alternatives, modifications and equivalents of the different features and exemplary embodiments. Many other examples will be immediately and directly clear to the skilled person on account of their technical knowledge in the light of the above description.

The exemplary embodiments have been selected and described in order to enable optimal illustration of the principles underlying the invention and its application possibilities in practice. Thus, experts can optimally modify and utilize the invention and its various exemplary embodiments in relation to the intended use. In the claims and in the description, the terms “containing” and “having” are used as linguistically neutral terms for the corresponding term “comprising”. Furthermore, the use of the terms “a”, “an” and “one” is intended not to rule out in principle a plurality of features and components described in this way.

### LIST OF REFERENCE SIGNS

1 metal-filled resin formulation
2 photopolymerizable matrix component
3 metallic filler
4 photopolymerized matrix component
5 cured material
6 manufacturing bath, manufacturing bed
7 control device
8 laser
9 laser beam
10 component
11 deflection mirror
12 work platform
13 lowering device
14 layer thickness
100 3D printing apparatus
M process
M1, M2 process steps

1. A metal-filled resin formulation (1), in particular for a 3D printing process (M), on the basis of photopolymerization for the manufacture of a component (10), more particularly a radiation-absorbing component (10), wherein the resin formulation (1) contains:
a photopolymerizable matrix component (2) which comprises at least one of monomers, oligomers and prepolymers from the group composed of mono- and/or polyfunctional radically and/or cationically polymerizable compounds,
a metallic filler (3) which has a density of at least 8.5 g cm⁻³, preferably at least 10 g cm⁻³, where the photopolymerizable matrix component (2) has a volume fraction of 5-80 vol %, preferably 5-70 vol %, particularly preferably 5-60 vol %, based on a sum of the photopolymerizable matrix component (2) and the metallic filler (3), and where the metallic filler (3) has a volume fraction of 20-95 vol %, preferably 30-95 vol %, particularly preferably 40-95 vol %, based on a sum of the photopolymerizable matrix component (2) and the metallic filler (3), and
a photoinitiator which is adapted to the photopolymerizable matrix component (2) and the light wavelength used for the photopolymerization, where the photoinitiator has a content of 0.05-10 phr, preferably 0.1-5 phr, particularly preferably 0.3-3 phr, based on the photopolymerizable matrix component (2),
where the metallic filler comprises a particulate fine fraction of less than 10% with a particle size smaller than one micrometer.

2. The resin formulation as claimed in claim 1,
characterized in that
the photopolymerizable matrix component (2) comprises at least one of acrylate, in particular methacrylate, acrylamide, in particular methacrylamide, vinyl esters, vinyl ethers and cyclic ethers.

3. The resin formulation as claimed in at least one of the preceding claims,
characterized in that
the photopolymerizable matrix component (2) is adapted for curing under irradiation with light of a wavelength of 150-1000 nm, preferably 200-550 nm.

4. The resin formulation as claimed in at least one of the preceding claims,
characterized in that
the metallic filler (3) comprises at least one of tungsten, molybdenum and tantalum.

5. The resin formulation as claimed in at least one of the preceding claims,
characterized in that
the metallic filler (3) has a particle size distribution with D10>2 μm and D90<100 μm.

6. The resin formulation as claimed in at least one of the preceding claims,
characterized in that
the metallic filler (3) has a monomodal or bimodal particle size distribution.

7. The resin formulation as claimed in at least one of the preceding claims,
characterized in that
the metallic filler (3) comprises rounded and/or round particles.

8. The resin formulation as claimed in at least one of the preceding claims,
characterized in that
the metal-filled resin formulation (1) further contains at least one of a rheology additive, a nanoparticle filler with particle sizes smaller than one micrometer, a light absorber, an adhesion promoter, a defoamer, a leveling additive and a thermal initiator, in particular in each case at a content of 0.01-20 phr based on the photopolymerizable matrix component (2).

9. A 3D printing process (M) on the basis of photopolymerization for the manufacture of a component (10), more particularly a radiation-absorbing component (10), using a metal-filled resin formulation (1) as claimed in any one of claims 1 to 8, wherein the 3D printing process (M) comprises:
provision (M1) of the metal-filled resin formulation (1) in a manufacturing bath, on a manufacturing bed (6) and/or as a wet layer, and
layer-by-layer selective curing (M2) of the metal-filled resin formulation (1) by polymerization in the manufacturing bath, on the manufacturing bed (6) and/or in the wet layer by means of selective light irradiation to form the component (10).

10. The 3D printing process as claimed in claim 9,
characterized in that
the 3D printing process (M) comprises at least one active light mask from the process types of stereolithography, liquid crystal display process and digital light processing.

11. An additively manufactured component (10), more particularly a radiation-absorbing component (10), which is manufactured with a 3D printing process (M) as claimed in claim 9 or 10.

12. The component as claimed in claim 11,
characterized in that
the component (10) is designed to absorb electromagnetic radiation with an energy of at least 1 keV, in particular at least 50 keV.

13. The component as claimed in claim 11 or 12,
characterized in that
the component (10) has wall thicknesses of less than 150 μm.

14. The component as claimed in at least one of claims 11 to 13,
characterized in that
the component (10) has a density of at least 4.5 g cm⁻³, preferably at least 6 g cm⁻³, particularly preferably at least 8 g cm⁻³.
